(19) United States
(12) Patent Application Publication
(10) Pub. No.: US 2016/0335250 A1
(43) Pub. Date: Nov. 17, 2016

(54) USER WARNINGS FOR CONTENT ITEMS PROJECTED TO UNDERPERFORM

(71) Applicant: Markus Breitenbach, Mountain View, CA (US)

(72) Inventor: Markus Breitenbach, Mountain View, CA (US)

(73) Assignee: Google Inc., Mountain View, CA (US)

(21) Appl. No.: 13/571,101

(22) Filed: Aug. 9, 2012

(51) Int. Cl. G06Q 30/02

(52) U.S. Cl. CPC G06F 17/2765

(57) ABSTRACT

Methods, systems, and apparatus, including computer programs encoded on a computer storage medium, for user warnings for content items projected to underperform. In one aspect a method includes identifying a first content item for display on a website. The method further includes determining a category of the first content item. The method further includes determining characteristics of the first content item, and identifying other well-performing content items in the category. The method further includes determining characteristics of the other well-performing content items, and contrasting the characteristics of the first content item with the characteristics of the other well-performing content items. In response to these contrasts, a recommendation is provided to a sponsor associated with the content item. The method further includes receiving, from the sponsor, at least one of a command, a replacement content item, or approval of the suggested changes.

### BACKGROUND

This specification relates to content selection.

The Internet provides access to a wide variety of resources. For example, video and audio files, as well as web pages for particular subjects or particular news articles, are accessible over the Internet. Access to these resources presents opportunities for content (e.g., advertisements) to be provided with the resources. For example, a web page can include slots in which content can be presented. These slots can be defined in the web page or defined for presentation along with a web page, for example, in a pop-up window.

### SUMMARY

In general, one innovative aspect of the subject matter described in this specification can be implemented in methods that include the actions of identifying a first content item for display on a website; determining a category of the first content item; determining one or more characteristics of the first content item; identifying one or more other well-performing content items in the category; determining one or more characteristics of the one or more other well-performing content items; contrasting the one or more characteristics of the first content item with the one or more characteristics of the one or more other well-performing content items; based on the contrasting, providing a recommendation to a sponsor associated with the first content item wherein the recommendation includes at least one suggested change to the first content item that if implemented would create more similarity between the one or more characteristics of the first content item and the one or more characteristics of the other well-performing content items than originally existed; and receiving, from the sponsor, at least one of (i) a command to submit the first content item for serving, (ii) a replacement content item, or (iii) an approval of the one or more suggested changes.

These and some implementations can each optionally include one or more of the following features. In some implementations, the one or more well-performing content items are those with click through rates above a threshold. In some implementations, determining one or more characteristics of the one or more other well-performing content items includes using logistic regression on data obtained from using log analysis on click-through data or inpression data of the one or more other well-performing content items. In some implementations, the replacement content item includes revisions to the first content item that (i) are similar to the at least one suggested change to the first content item, and (ii) create more similarity between the one or more characteristics of the first content item and the one or more characteristics of the other well-performing content items. In some implementations, the approval of the one or more suggested changes includes receiving from the sponsor a command to accept the one or more suggested changes and to submit the first content item for serving. The actions further include receiving, from the sponsor, one or more commands to contrast the one or more characteristics of a revised content item with the one or more characteristics of the one or more other well-performing content items; and rejecting the revised content item for additional contrasting after receiving a particular number of the one or more commands to contrast the one or more characteristics of a revised content item with the one or more characteristics of the one or more other well-performing content items. In some implementations, determining a category of the content item includes receiving, from the sponsor associated with the content item, the category of the content item.

Particular implementations may realize one or more of the following advantages. User warnings for content items can improve content item performance. User warnings for content items can improve a user's web browsing experience by presenting better quality content items. User warning for content items can improve future content items created by sponsors who learn what characteristics typically belong to well performing content items.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example content serving environment.

FIG. 2 is another example content serving system.

FIGS. 3A and 3B are example screen shots of a user interface that is used to create content and receive recommendations regarding the content.

FIG. 4 is a flowchart of an example process for providing recommendations to content sponsors.

FIG. 5 is block diagram of an example computer system that can be used to create campaigns and allocate content in response to resource requests.

Like reference numbers and designations in the various drawings indicate like elements.

### DETAILED DESCRIPTION

Small and medium size sponsors may not be familiar with how to create a successful online campaign. The success of an online campaign can often turn on a content item's formatting, capitalization, punctuation, or a combination of these and other characteristics of the content. In order to create successful online campaigns, a sponsor can create a content item by completing an online form that specifies different fields that together make up a content item. For example, the sponsor can specify a title, subheading, a website address, a physical address, and a phone number. The sponsor can also specify a category that best fits the content item such as bakery or dentist. Upon providing the content item, a system reviews the content item and compares it to other content items in the same category that have performed well. The system provides recommendations to the sponsor about what qualities the well-performing content items have that may be missing in the sponsor's content item. The sponsor may elect to follow the recommendations or submit the content item for serving as part of an online campaign.

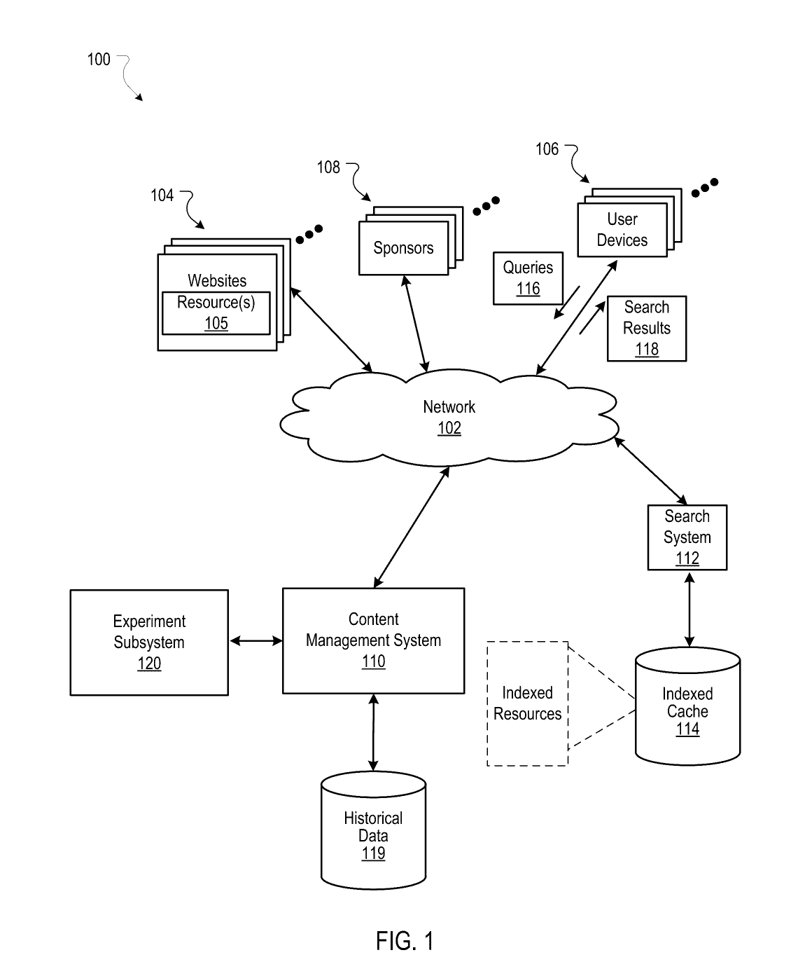

FIG. 1 is a block diagram of an example environment 100 in which a content management system 110 manages content delivery. The example environment 100 includes a network 102, such as a local area network (LAN), a wide area network (WAN), the Internet, or a combination thereof. The network 102 connects websites 104, user devices 106, content sponsors 108, and the content management system 110. The example environment 100 may include many thousands of websites 104, user devices 106, and content sponsors 108.

A website 104 is one or more resources 105 associated with a domain name and hosted by one or more servers. An example website is a collection of web pages formatted in hypertext markup language (HTML) that can contain text, images, multimedia content, and programming elements, such as scripts. Each website 104 is maintained by a publisher, which is a sponsor that controls, manages and/or owns the website 104.

A resource 105 is any data that can be provided over the network 102. A resource 105 is identified by a resource address that is associated with the resource 105. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as JavaScript scripts).

A user device 106 is an electronic device that is under control of a user and is capable of requesting and receiving resources over the network 102. Example user devices 106 include personal computers, mobile communication devices, tablet devices, set top boxes, smart phones and other devices that can send and receive data over the network 102. A user device 106 typically includes a user application, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display (e.g., a presentation location of a pop-up window or in a slot of a web page) in which sponsored content can be presented. These specified portions of the resource or user display are referred to as slots.

To facilitate searching of these resources, the environment can include a search system 112 that identifies the resources by crawling and indexing the resources provided by the publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 accesses the indexed cache 114 to identify resources that are relevant to the search query 116. The search system 112 identifies the resources in the form of search results 118 and returns the search results 118 to the user devices 106 in search results pages. A search result 118 is data generated by the search system 112 that identifies a resource that is responsive to a particular search query, and includes a link to the resource. An example search result 118 can include a web page title, a snippet of text or a portion of an image extracted from the web page, and the URL of the web page. Search results pages can also include one or more slots in which sponsored content can be presented.

When a resource 105 or search results 118 are requested by a user device 106, the content management system 110 receives a request for content to be provided with the resource 105 or search results 118. The request for content can include characteristics of the slots that are defined for the requested resource or search results page, and can be provided to the content management system 110. In other implementations, the content management system 110 can receive a request for content outside of a search system. For example, an email provider, website publisher, or a social network provider may request content.

For example, a reference (e.g., URL) to the resource for which the slot is defined, a size of the slot, and/or media types that are available for presentation in the slot can be provided to the content management system 110. Similarly, keywords associated with a requested resource (“resource keywords”) or a search query 116 for which search results are requested can also be provided to the content management system 110 to facilitate identification of content items that are relevant to the resource or search query 116.

Based on data included in the request, the content management system 110 can select content items that are eligible to be provided in response to the request (“eligible content”). For example, eligible content can include content having characteristics matching the characteristics of slots and that are identified as relevant to specified resource keywords or search queries 116. In some implementations, content items having associated keywords that match the resource keywords or the search query 116 are selected as eligible content by the content management system 110.

The content management system 110 can select the eligible content items that are provided for presentation in the slots of a resource or search results page based on results of an auction. For example, the content management system 110 can receive bids from content sponsors and allocate the slots to the highest bidders at the conclusion of the auction. The bids are amounts that the sponsors are willing to pay for presentation (or selection) of their content with a resource or search results page. For example, a bid can specify an amount that a sponsor is willing to pay for each 1000 impressions (i.e., presentations) of the content, referred to as a CPM bid. Alternatively, the bid can specify an amount that the sponsor is willing to pay for a selection (i.e., a click-through) of the content or a “conversion” following selection of the content. The highest bidders can be determined based on the bids alone, or based on the bids of each bidder being multiplied by one or more factors, such as quality scores derived from any number of factors including performance, landing page scores, and the like.

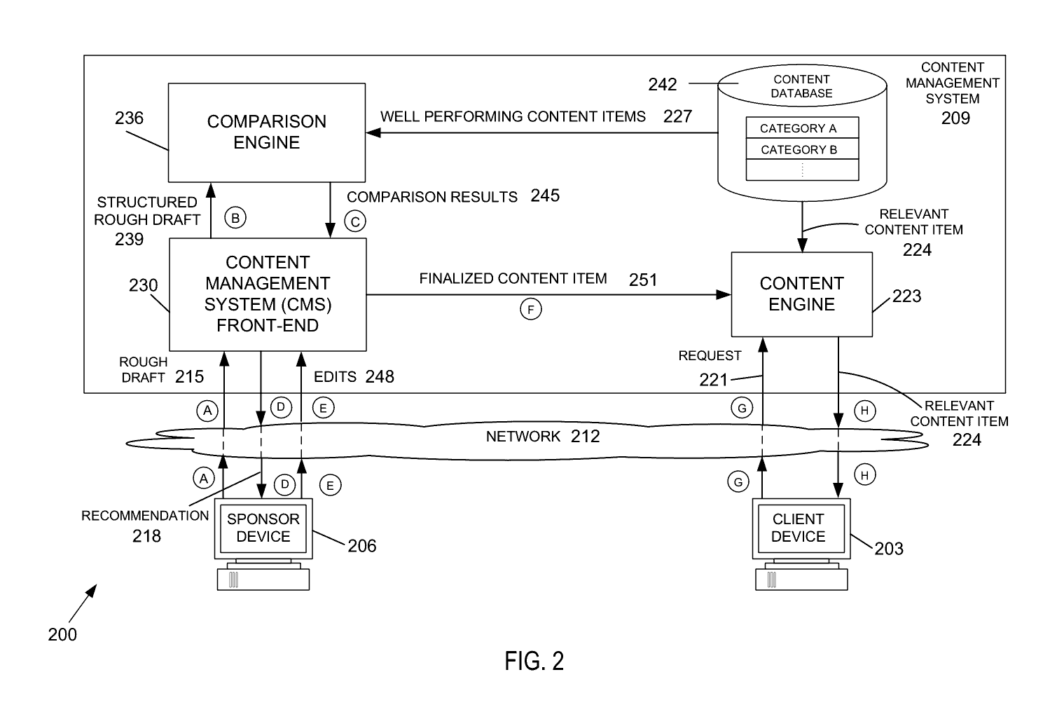

FIG. 2 is an example content serving system 200 that enables sponsors to provide content items that are to be evaluated by the system and provided to users. The content serving system 200 is similar to the example environment 100 and the components of the network 102, the user devices 106, the sponsors 108, and the content management system 110 have similar counterparts in the content serving system 200. In general, the system 200 includes a client device 203, similar to one of the user devices 106, and a sponsor device 206, similar to sponsors 108, coupled to a content management system 209, similar to content management system 110, over a network 212, similar to network 110. The content management system 209 receives a rough draft 215 from the sponsor device 206 over the network 212, and the content management system 209 provides a recommendation 218 related to the rough draft 215 to the sponsor device 206 over the network 212. Additionally, the content management system 209 receives a request 221 from the client device 203 over the network 212, and the content management system 209 provides a relevant content item 224 to the client device 203 over the network 212. The content management system 209 provides additional detail not shown in content management system 110.

The recommendation 218 provided by the content management system 209 can include one or more suggestions to the sponsor on how to improve the rough draft 215. The recommendation 218 can be generated in numerous ways, including comparing the rough draft 215 to well performing content items 227.

The relevant content 224 provided by the content management system 209 can include one or more content items for presentation to the user of client device 203. The relevant content 224 can be generated in numerous ways, including examining data included in the request 221.

In some implementations, the content management system 209 can generate the recommendation 218 by analyzing the rough draft 215. In some implementations, the content management system 209 compares the rough draft 215 to other content items that have performed well. In some implementations, the content management system 209 compares the rough draft 215 to other content items in a same category as the content associated with the rough draft 215. The category can be specified by the sponsor when providing the rough draft 215 or can be determined by the content management system 209. For example, given the example rough draft 215:
Tartine Bakery!!!!
we have some of the best bread
try some today
   and the sponsor specified category of “bakery,” the content management system 209 can provide the recommendation 218 such as “Content without capitalization typically performs poorly” after comparing the content to other well performing content items in the bakery category. In other implementations, the recommendation 218 may include a suggested revision. For example, the recommendation 218 may be “Revise ‘we have some of the best bread’ to ‘We Have Some of the Best Bread.’” The suggested revision can be a type of revision that complies with a characteristic of the well performing content items 227. The system may present the option of accepting the suggested revision.

The content management system 209 can be implemented as, for example, computer programs running on one or more computers in one or more locations that are coupled to each other through a network. In some implementations, the content management system 209 includes a content management system (“CMS”) front end 230 (or “gateway server”) to coordinate requests between other parts of the content management system 209 and the sponsor device 206. The content management system 209 also includes a content engine 233 and a comparison engine 236.

An “engine” (or “software engine”) can refer to a software implemented input/output system that provides an output that is different than the input. An engine may be an encoded block of functionality, such as a library, a platform, Software Development Kit (“SDK”), or an object. The network 120 may include, for example, a wireless cellular network, a wireless local area network (“WLAN”) or Wi-Fi network, a Third Generation (3G) or Fourth Generation (4G) mobile telecommunications network, a wired Ethernet network, a private network such as an intranet, a public network such as the Internet, or any appropriate combination thereof.

The CMS front end 230, content engine 233, and comparison engine 236 can be implemented on any type of computing device (e.g., servers, mobile phones, tablet computers, music players, e-book readers, laptop or desktop computers, PDAs, smart phones, or other stationary portable devices) that includes one or more processors and computer readable media. Among other components, the sponsor device 206 and client device 203 both include one or more processors, computer readable media that store software applications (e.g., a browser layout engine), an input module (e.g., a keyboard or mouse), communication interface, and a display. The computing device or devices that implement the CMS front end 230, the content engine 233, and the comparison engine 236 may include similar or different components.

In general, the CMS front end 230 receives the rough draft 215 from the content management system 209 and routes the rough draft 215 to the appropriate engines so that the recommendation 218 may be generated. In some implementations, routing occurs by referencing static routing tables, or routing may occur based on the current network load of an engine, so as to accomplish a load balancing function. The CMS front end 230 also provides the resulting recommendation 218 to the content management system 209. In doing so, the CMS front end 230 acts as a gateway, or interface, between the content management system 209 and the content engine 233. In some implementations, the content management system 209 contains many hundreds or thousands of computing devices to process the content from the content management system 209 and provide the content items to the client device 203.

In FIG. 1, a sponsor provides a rough draft 215 during state (A), and the sponsor device 206 communicates the rough draft 215 to the content management system 209 over the network 212. The sponsor may submit the rough draft 215 by typing or speaking the desired text of the rough draft 206 into the sponsor device 206, then pressing a submit, next, review, or other type of control button on the sponsor device 206.

In some implementations, the sponsor submits the rough draft 215 in various pieces. For example, the sponsor can submit a headline, text, a landing page address, physical address, phone number, a category, or any combination of these items. In some implementations, the headline is the name of the sponsor. The text can be a short description of the product/service the sponsor is trying to sell or a short description of the sponsor's business. The landing page address is an address of a webpage that a user is directed to when the user interacts with (e.g., clicks on) the content item. The physical address and phone number can be those of the sponsor. In some implementations, the category is not shown in the content item, but is used by the content management system 209 for comparison to other content.

During state (B), the CMS front end 230 receives the rough draft 215 and communicates a structured rough draft 239 to the comparison engine 236. The comparison engine 236 uses content from the content database 242 to compare to the structured rough draft 239. In some implementations, the structured rough draft 239 is the text of the rough draft 215 with additional markers to specify the different items in the content item. For example, the rough draft 215 could be:
Tartine Bakery!!!!
we have some of the best bread
try some today
   and the structured rough draft 239 could be (“Tartine Bakery!!!!”, “we have some of the best bread”, “try some today”, “plus.google.com/tartinebakery”, “bakery”, 1, 1) (headline, text line 1, text line 2, landing page address, category, physical address flag, phone number flag).

During state (C), the comparison engine 236 compares the rough draft 239 to well performing content items 227 in the content database 242 that are in the same category and delivers comparison results 245 to the CMS front end 230. In some implementations, the well performing content items 227 are represented as a series of characteristics that the comparison engine 236 has gathered from all the well performing content items. For example, the comparison engine 236 can review the content items in each category in the content database 242 to see which ones have the highest click through rate. The comparison engine 236 may observe that the content items in the bakery category that perform well use some capitalization in the text. The comparison engine 236 may observe that the content items in the bakery category that perform well have more than ten characters in the title. Further, the comparison engine 236 may observe that the structured rough draft 239 violates particular rules of the content management system 209. For example, the comparison engine 236 may observe that the title contains exclamation marks and, depending on the settings, that may violate a rule against exclamation mark in a content item.

The data related to well-performing content items can be compiled online in real time. For example, when a user clicks on a content item on the client device 203, data indicating a click-through for the content item can be updated. Another example, is when the content management system 209 selects a content item for display on the client device 203, then data indicating a display of the content item can be updated. A display of the content item is also called an impression. In some implementations, the data related to well performing content items can be gathered when the content management system 209 is online but not processed until the content management system 209 is offline. For example, click-through and display data can be gathered and stored in a log file. When the content management system 209 is offline, it or another system can process the log file and update each content item in the content database 242 with the click-through and display data.

In some implementations, the well-performing content items 227 can be the content items with the highest click through rate or the ones that are displayed the most. In some implementations, the click through rates or the impressions can be normalized to account for content items that have been in the content database 242 longer. For example, click through rates and display rates can be calculated on a per day, week, year, etc. basis. In some implementations, well performing content items are determined using log file analysis. For example, by counting how many impressions of an content item were shown and how many corresponding click-throughs are recorded, the click-through rate of a content item can be determined. Other metrics could be computed in a similar fashion, for example, revenue and cost per click. By grouping these metrics of the content items by category, the content management system 209 can compare how well a particular content item is performing relative to other content items in the same category. The content items can be grouped in deciles in order of performance such that the lowest performing content items are in the bottom 10 percent and the highest performing content items are in the top 10 percent. In some implementations, the threshold for well-performing content items is measured in terms of a certain percentile with respect to other content items in the database. For example, well performing content items 227 can be the ones which are in the top twenty percent of click through rates or number of displays or both. In some implementations, the well performing content items 227 can be a content item at the median or above of click through rates or number of displays.

Once the well-performing content items 227 are identified by the comparison engine 236, the comparison engine 236 can gather common qualities of the well performing content items. For example, the comparison engine 236 may observe that well performing content items have at least ten characters in the title. The comparison engine 236 may observe that well performing content items use a mix of capital and lowercase letters in the text portion of the content item.

During state (D), the CMS front end 230, presents, to the sponsor on the sponsor device 206, the recommendation 218 that was determined by the comparison engine 236. In some implementations, the recommendation 218 is color coded to indicate an importance level of the feedback. For example, if more than ninety percent of the well performing content items contained greater than ten words in their title, then the recommendation 218 could be displayed in a color associated with a high importance item (such as red). If between sixty and ninety percent of the well performing content items used capitalization in their text, then the recommendation 218 could be displayed in a color associated with a moderate importance level (such as yellow). In some implementations, the recommendation 218 can be notices that a rule of the content management system 209 was violated and those notices can be formatted differently also. For example, if the content item contained exclamation points, then the recommendation 218 could be underlined. Any combination of font, font size, font color, bold, underline, italics, etc. can be used to differentiate different levels of the recommendation 218. In some implementations an indicator bar is provided next to the recommendation 218. For example, if the recommendation 218 was one that was followed by 90 percent of the well performing content items 227, then the indicator bar can be 90 percent full. If the recommendation 218 was followed by 50 percent of the well performing content items 227, then the indicator bar can be 50 percent full.

During state (E), the sponsor responds to the recommendation 218 with edits 248 using the sponsor device 206 and through the network 212. In some implementations, the sponsor does not follow the recommendation 218 and the submission (e.g., edits 248) are the same as the rough draft 215. In some implementations, the sponsor changes one or more aspect of the content item and sends a second rough draft for review again by the content management system 209. The same procedure outlined in states (A) through (D) can be repeated for a second rough draft. In some implementations, the sponsor may be limited in the number of revisions that the sponsor can send through the content management system 209. For example, the content management system 209 may limit the number of revisions to ten. After ten revisions, the sponsor may be required to submit the content item to the content engine 233 or withdraw his/her content item from the content management system 209.

During state (F), the CMS front end 230 sends the finalized content item 251 to the content engine 233. In some implementations, the CMS front end 230 formats the finalized content item 251 so that it can be stored in the content database 242. For example, the content item
Tartine Bakery
We have some delicious bread
Try some today
   may be formatted in the following manner: (“Tartine Bakery”, “We have some delicious bread”, “Try some today”, “plus.google.com/tartinebakery”, “bakery”, 1, 1) (headline, text line 1, text line 2, landing page address, category, physical address flag, phone number flag). Once the finalized content item 251 is stored in the content database 242, the content management system 209 can then serve the finalized content item 251 to the client device 203 through the network 212.

During state (G), the client device 203 requests a content item from the content management system 209 by sending a request 221 to the content management system 209 through the network 212.

During state (H), the content engine 233 selects a relevant content item 224 from the content database 242 based on the data in the request 221. The relevant content item 224 is delivered to the client device 203 through the network 212.

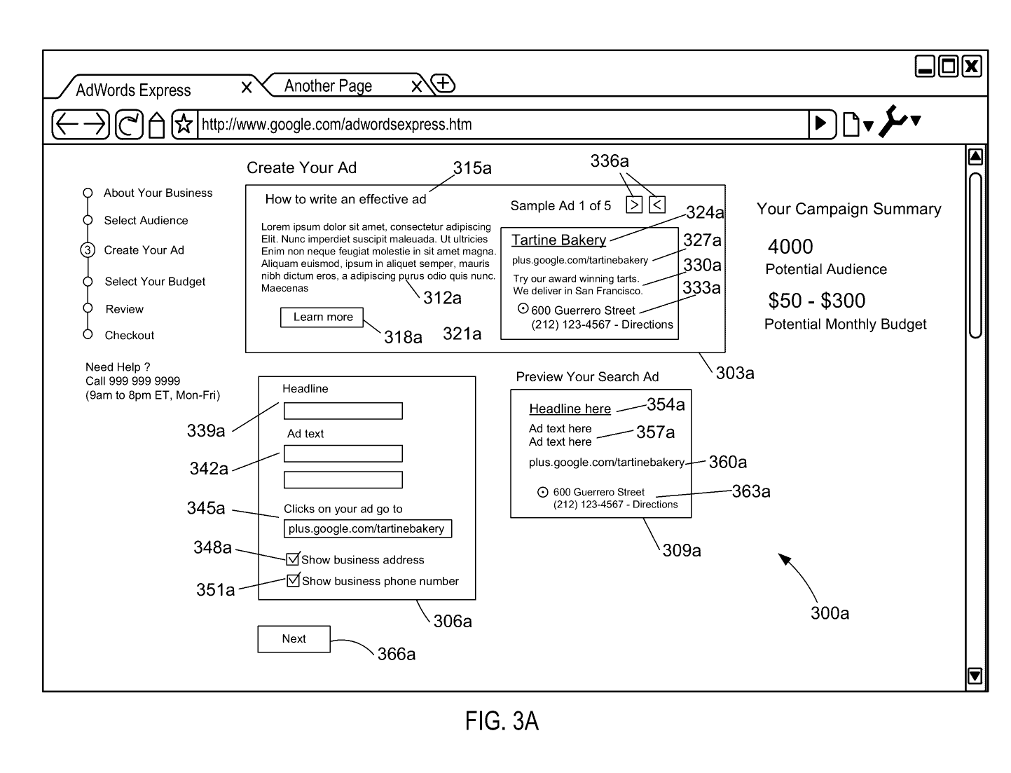

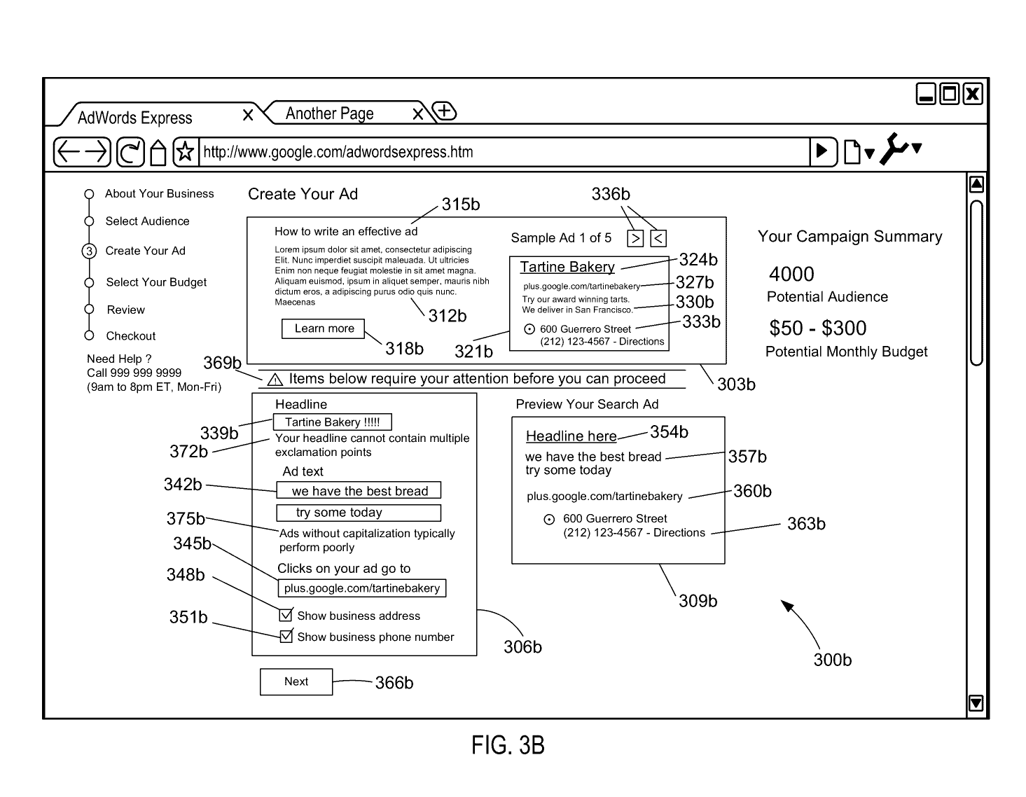

FIG. 3A is an example screen shot of a user interface 300a that is used by a sponsor to create content and receive feedback regarding the content. The user interface 300a presents an instruction box 303a for presenting instructions to the sponsor. The instructions assist the sponsor in creating a content item in input box 306a. The preview box 309a displays the text of the content item that the sponsor provides into input box 306a.

The instruction box 303a contains an instruction area 312a that displays instructions or tips or both for the sponsor. In the implementation shown, the instruction area 312a also contains an instruction area title 315a that provides a summary of the presented instruction. To learn more about the instruction, the sponsor can select an instruction control button 318a. In some implementations, selection of the instruction control button 318a causes the instruction area 312a to display more detail regarding the instructions. In some implementations, selection of the instruction control button 318a causes another window to open where the sponsor can navigate more detailed instructions.

The instruction box 303a contains an example box 321a where example content items can be displayed. The example box 321a contains an example content item with an example title 324a, an example landing page address 327a, an example text 330a, and an example physical address and phone number 333a. In close proximity to the example box 321a are control buttons 336a that the sponsor can select to navigate through the different sample content items. In some implementations, the sample content items are in the same category as the category selected by the sponsor. In some implementations, the content items are in categories that the content management system 209 considers most relevant to the entered content item. In some implementations, the sample content items are selected from the well-performing content items in the same category selected by the sponsor. In some implementations, the example content item is a fully functioning content. For example, if the sponsor selected the “Directions” link on the example address 333a, then the sponsor would be directed to a page that provides directions to the address in example physical address and phone number 333a. If the sponsor selected the example landing page address 327a, then the sponsor would be directed to the landing page.

The input box 306a contains several areas for the sponsor to input one or several portions of a content item. The headline input area 339a is an input area for the headline of the content item. For example, the sponsor can input the title of the business in the headline input area 339a such as “Tartine Bakery.” The text input area 342a is an input area for the subheading of the content item. For example, the sponsor can input “try our award winning bread” in one line and “we use 100% whole wheat” in the other line. In some implementations, the text input area 342a can contain a specific number of lines to accept input. In some implementations, the sponsor can select the number of lines for text input area 342a. The landing page address input area 345a is an input area for the landing page address. The landing page address is the web page address that the content item viewer is directed to when the viewer interacts with (e.g., clicks on) the content item. For example, the sponsor can input “plus.google.com/tartinebakery” and the content item viewer will be directed to this link when the viewer clicks on the content item. The physical address selection box 348a and the phone number selection box 351a allow the sponsor to select whether or not to display the physical address or phone number or both of the sponsor. In some implementations, the sponsor's account already contains the address and phone data, thus only a selection box is needed. In some implementations, the sponsor can input the address and phone data directly into an input area in input box 306a. In some implementations, the sponsor may be limited by the number of characters that the sponsor can input into the input areas. For example, each line may be limited to 30 characters and additional input may not be displayed beyond 30 characters. Furthermore, input into these areas need not be by way of a keyboard. In some implementations, voice input or touch screen input can be used to fill in the input areas. Some data can be filled automatically by retrieving it from a database if the data is already known. For example, a business address of the sponsor is frequently known at the time of signup if the sponsor has already signed up for a related account.

The preview box 309a contains a preview of the content item that the sponsor inputted into the input box 306a. In some implementations, the preview box 309a updates as the sponsor inputs characters into the input box 306a. For example, as the sponsor types “Tartine Bakery” into the headline input area 339a, the headline preview 354a updates in real time. Additionally, an text preview 357a, a landing page address preview 360a, and a physical address and phone number preview 363a display a preview of the content item as their respective input area is updated by the sponsor. In some implementations, the preview box 309a includes live links that the sponsor can select. For example, the sponsor can click on the content item in the preview box 309a and be directed to the landing page from the landing page address input area 345a. Additionally, the sponsor can select the directions link in the physical address and phone number preview 363a and be directed to a page displaying directions to the address listed. In some implementations, the preview box 309a may not update in real time as the sponsor inputs data into the input box 306a, but rather update as the sponsor switches between input areas. For example, the sponsor can input “Tartine Bakery” into headline input area 339a, then upon switching to input data into the text input area 342a, the headline preview 354a can update with “Tartine Bakery.”

In some implementations, the user interface 300a contains a control element 366a that the sponsor can select when the sponsor has completed input of the content item. In some implementations, the sponsor selects the control element 366a to send the content item to the comparison engine 336a. In some implementations, there are multiple control elements. For example, user interface 300a may contain a control element to save the content item for display on client devices or a control element to exit the user interface 300a and abandon the content item or both. In some implementations, some of the control elements may be unavailable for selection by the sponsor. For example, if the sponsor has submitted the content item for review too many times, then a submit for review control element may be visible but unavailable for selection.

FIG. 3B is an example screen shot of a user interface 300b that is used to create content and receive feedback regarding the content. In some implementations, the user interface 300b is displayed after a sponsor selects the control element 366a. Similar to user interface 300a, the user interface 300b contains an instruction box 303b that contains instructions, tips, and sample content items; an input box 306b for the sponsor to edit and revise the content item, in addition to view various suggestions; and a preview box 309b for the sponsor to preview the content item inputted into the input box 306b.

The user interface 300b contains the recommendation 218 from the content management system 209. For example, the user interface 300b contains a review notice 369b which presents to the sponsor a message that some data that the sponsor inputted into the input box 306b needs the sponsor's attention. The review notice 369b can be a static message which will update upon selection of control element 366b, or the review notice 369b can be a dynamic message which will update or cease to be displayed once the sponsor has satisfied the requirements noted in input box 306b. The review notice 369b can be displayed in different fonts or colors. For example, the review notice 369b can be displayed in yellow if the feedback contains only suggested revisions. The review notice 369b can be displayed in red if the feedback contains required revisions. In some implementations, the review notice 369b is displayed with a status bar that indicates the level of editing required.

In the user interface 300b, headline notice 372b contains a message to the sponsor regarding a content rule violation or content suggestion. In some implementations, the headline notice 372b can be category specific. For example, a headline notice 372b may display that exclamation points are not allowed when reviewing a content item for a sponsor in the bakery business. In another example, there may not be a headline notice 372b even if there are exclamation points in the headline area 339 because the sponsor's business is in the editing and typing category. In some implementations, the headline notice 372b can be displayed in different colors depending on the suggestion. For example, if the headline notice 372b displays the message “Reviewed: no apparent problems,” then the headline notice 372b may be displayed in green. If the headline notice 372b displays the message “Headline cannot contain ‘best,’” then the headline notice 372b may be displayed in red. If the headline notice 372b displays the message “Headlines with more than 10 characters typically perform better,” then the headline notice 372b may be displayed in yellow. In some implementations, the headline notice 372b is paired with a status bar which indicates a level/importance of rule presented in the headline notice 372b. For example, the status bar may indicate a low level suggestion be displayed in green, a medium level suggestion related to improving content performance be displayed in yellow, or a high level rule violation be displayed in red. If a status bar is used, then the headline notice 372b may be displayed in black font. The status bar can be filled to a low level for a low level suggestion, to a medium level for a suggestion related to improving content performance, or a high level for a rule violation.

In the user interface 300b, text notice 375b contains a message to the sponsor regarding a suggestion. For example, text notice 375b displays “Ads without capitalization typically perform poorly.” In some implementations, the messages can be category specific. For example, in the bakery category, the comparison engine 236 may conclude “Ads without capitalization typically perform poorly.” In the photography category, capitalization may not be a common characteristic of well performing content items, and therefore, no text notice 375b is displayed or a text notice 375b is displayed that reads “Reviewed: no apparent problems.” Similar to headline notice 375b, the text notice 375b can be displayed in different fonts or colors or a status bar can be displayed or both.

In some implementations, both the text notice 375b and the headline notice 372b can be static or dynamic. For example, once the exclamation points are removed from “Tartine bakery !!!!,” then the text notice 375b can be updated.

Additional notice messages may be displayed in the user interface 300b. For example, if the comparison engine 236 determines that a business address or a phone number or both are typically displayed in well performing content items, then a notice message may be displayed near the address selection box 348b or the phone number selection box 351b.

In the user interface 300b, the sponsor updates the input areas where the notices were displayed and then selects the control element 366b. In some implementations, there is an additional control element that allows the sponsor to resubmit the content item for review to the comparison engine 236. For example, a control element may display “Resubmit for review.” In other examples, a control element may display “Resubmit and select a new category.”

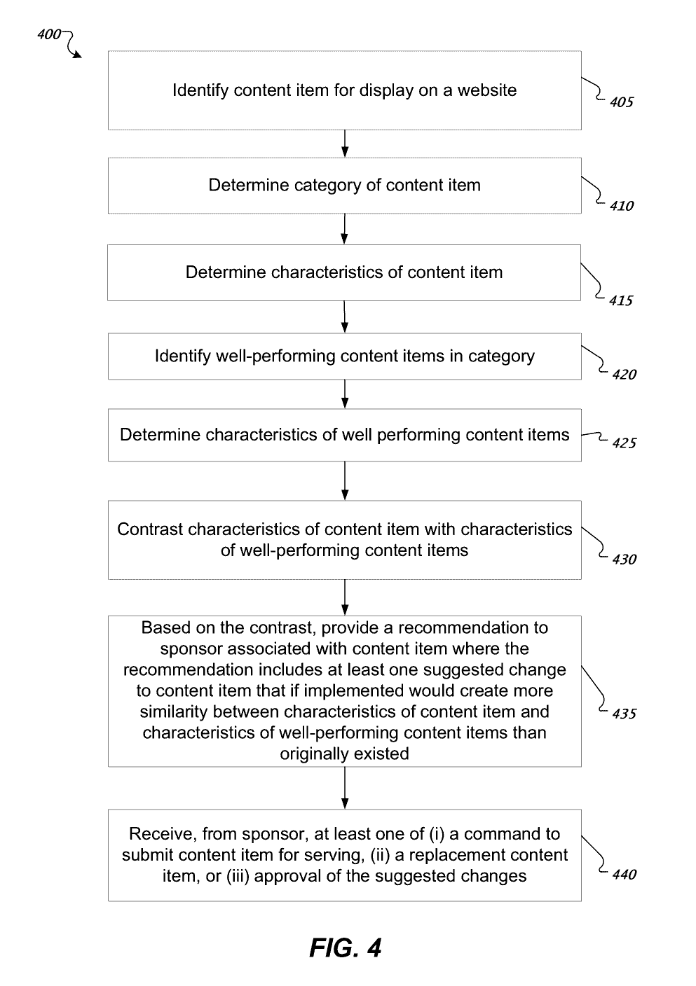

FIG. 4 is a flowchart of an example process 400 for providing feedback to content sponsors. In general, the process 400 analyzes a content item provided by a sponsor against other well performing content items in the same sponsor-selected category and provides feedback to the sponsor. The process 400 will be described as being performed by a computer system comprising one or more computers, for example, the content management system 209 as shown in FIG. 2.

The system identifies a content item for display on a website (405). In some implementations, the system identifies a content item from data input from a sponsor. For example, a sponsor logs into the content management system 209 and begins to enter data for a content item to display online to users of the client device 203, then the system can package and create a content item for display to the user while the user is using the client device 203. In some implementations, the data includes the sponsor's business name, a description of the business, a web address of a landing page, a physical address of the sponsor, a phone number, or any combination of these items. In some implementations, the data is stored within the sponsor's account in the content management system 209 and does not need to be entered for each new content item. For example, the sponsor's physical address or phone number may be stored in the sponsor's profile. In some implementations, the content item is an advertisement.

The system determines a category of the content item (410). In some implementations, the category of the content item is provided by the sponsor. For example, a sponsor in the bakery business may select bakery as the category for the content item. In some implementations, the category is selected by the content management system 209 based on the characteristics of the content item or sponsor. For example, the category may be based on the text of the content item, the name of the sponsor, data from the landing page, or any other data associated with the sponsor in the content management system 209. In some implementations, the category can be selected by the sponsor, then submitted to the content management system 209. The content management system 209 can recommend alternate categories based upon the submitted content item and the selected category. The sponsor can choose one of the recommended categories or maintain the sponsor's category choice. In some implementations, the content management system 209 can suggest categories based upon the content item provided by the sponsor. The sponsor may choose from the suggested categories or select a different category that the sponsor believes better represents the content item. In some implementations, the category can be constant for each content item entered by the sponsor or the category can be different for each content item entered by the sponsor. In some implementations, the category may only be from a set of predetermined categories.

The system determines characteristics of the content item (415). Characteristics can relate to any aspect of the content item including the title, the text, the landing page address, the landing page content, the physical address, or the phone number. The characteristics can relate to number of characters, punctuation, grammar, word relationships, or number of words. For example, the system can determine that the title does not contain any capitalized letters. The system can determine that the title contains ten characters or that there is no phone number included in the content item. The system can determine that the landing page address does not match well with the title such as if the title was “Tartine Bakery” and the landing page address was “plus.google.com/aardvarkschool.”

The system identifies one or more other well-performing content items in the category (420). In some implementations, the content management system 209 gathers the click-through rates of the other content items in the same category as the entered content item. The content items with the highest click through rates are determined to be well-performing ones. In some implementations, the content items with click through rates in the highest percentile are determined to be well performing. For example, the content items with click through rates in the top ten percent of click through rates are determined to be well performing. In some implementations the click through rates are normalized to account for different lengths of time each content item is in the content management system 209. For example, a content item with 10 click throughs that has been in the content management system 209 for 10 days will be ranked the same as a content item with 50 click throughs that has been in the content management system 209 for 50 days. In some implementations, if a content item has a number of click throughs that is higher than a threshold, then it is considered well performing. In some implementations, if a content item has a normalized click through rate higher than a threshold, then it is considered well performing.

Well performing items can also be identified based on the number of times the content item is displayed to a user on a client device. For example, a content item that has been displayed more times than another content item is more likely to be considered well performing. In some implementations, the content items with displays in a certain percentile are considered well performing. For example, content items with a number of displays in the top 10 percent of content items are considered well performing. In some implementations, the content management system 209 normalizes the number of displays based on time. For example, a content item with 10 displays that has been in the content management system 209 for 10 days will be ranked the same as a content item with 50 displays that has been in the system for 50 days. In some implementations, if a content item has a number of displays that is higher than a threshold, then it is considered well performing. In some implementations, if a content item has a normalized number of displays higher than a threshold, then it is considered well performing. In some implementations, the click through rate normalized by the number of displays is used to determine the content items that are well performing. For example, a content item with 10 clicks and 20 displays will be ranked higher than a content item with 20 clicks and 100 displays. In some implementations, there is a minimum number of click throughs, displays, or time in the content management system 209 before a content item can be considered well performing.

The system determines one or more characteristics of the one or more other well-performing content items (425). In some implementations, the one or more characteristics are determined by aggregating the well performing content items and determining which characteristics are common to all of them or a particular percentage of them. For example, fifty percent of the well performing content items may use capitalization, or all of the well performing content items may have more than 10 characters in the title. Characteristics can relate to any aspect of the content items including the title, the text, the landing page address, the landing page content, the physical address, or the phone number.

In some implementations, the one or more characteristics can be determined using logistic regression on data obtained from log analysis. For example, by creating independent variables for use in a logistic regression model such as the number of characters in each line, punctuation characters used, capitalization of words used, and other characteristics, the content management system 209 can calculate the change in probability that a content item will perform well. With these characteristics and by examining weights that can assigned to each one, the content management system 209 may find that at least one word other than at the beginning of the line should be capitalized, that question marks at the end of the title are detrimental to performance of the content item, or that having words related to the category in the title is beneficial.

The system can contrast the one or more characteristics of the first content item with the one or more characteristics of the one or more other well-performing content items (430). In some implementations, only particular characteristics of the content item are compared to the characteristics of the well performing content items. For example, only the title and text may be compared to the characteristics. Thus, only the title and the text would be analyzed to determine if they contained, for example, capitalization or a threshold number of characters.

The system provides a recommendation to a sponsor associated with the content item. The recommendation includes at least one suggested change to the first content item that if implemented would create more similarity between the one or more characteristics of the first content item and the one or more characteristics of the other well-performing content items than originally existed (435). After comparing the sponsor's content item to the well performing content items, the content management system 209 generates recommendations for display to the sponsor in the user interface 300b. In some implementations, the recommendations are color coded. For example, a recommendation that the sponsor must follow is in red and a recommendation that the sponsor may follow is in yellow. In some implementations, the recommendations are paired with a visual indicator that can display the level of recommendation. For example, if the sponsor must follow the recommendation, then a visual indicator that is a status bar may be full. If the sponsor may follow the recommendation, then a visual indicator that is a status bar may be half full. In some implementations, the visual indicator is tied to the number of well performing content items that share the characteristic. For example, twenty percent of the well performing content items have a title with greater than ten characters, then the visual indicator may be twenty percent full. In some implementations, the visual indicator may be tied to the expected performance of the sponsor's content item. For example, if the number of well performing ads that share the recommended characteristic have an average click through rate, then that average click through rate can be displayed on the visual indicator.

The system receives, from the sponsor, at least one of (i) a command to submit the content item for serving, (ii) a replacement content item, or (iii) approval of the one or more suggested changes (440). Once the content management system 209 has displayed a recommendation to the sponsor, the sponsor decides whether to accept it or not. For example, the sponsor can revise the content item and resubmit the content item to the content management system 209 for another review. The sponsor can also replace the content item with a new content item and the new content item may be submitted for serving to a client device or submitted for review. The sponsor can also submit the content item for serving to a client device without revising the content item according to the recommendation. The sponsor can also log out from the content management system 209 and not submit the content item for serving to a client device.

In some implementations, each time a sponsor resubmits a content item for review, the content management system 209 increments a counter. If the counter reaches a certain threshold, then the sponsor may not be allowed to resubmit the content item for further review. For example, if a sponsor submits for review and revises a content item ten times, then on the eleventh time, the sponsor does not have the choice to submit the content item for review. The sponsor may only submit the content item for serving on client devices or abandon the content item. In some implementations, the sponsor may have a total number of reviews for all the sponsor's content items and once the sponsor exceeds that number, then the sponsor may only be able to choose between selecting the content item for serving to a client device or abandoning the content item. In some implementations, the number of reviews may be based on a period of time. For example, the sponsor may have 10 reviews of content items per day. In some implementations, the sponsor may purchase additional reviews.

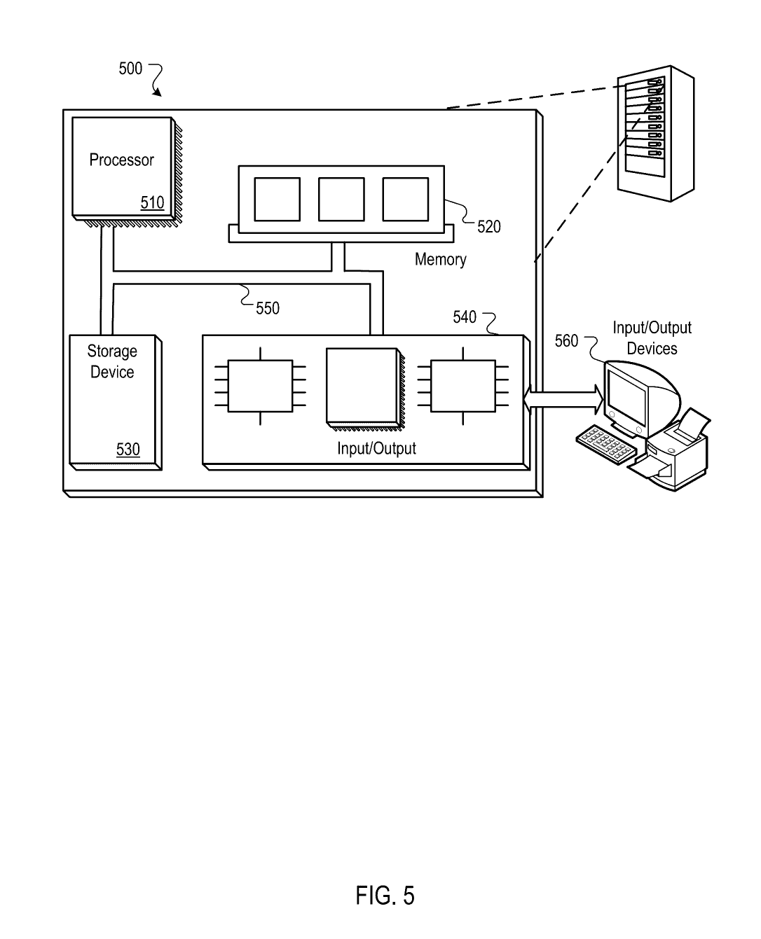

FIG. 5 is block diagram of an example computer system 500 that can be used to create experiment campaigns and allocate content in response to resource requests. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Some implementations, however, can also be used, such as mobile computing devices, mobile communication devices, set-top box television client devices, etc.

The experiment subsystem 520 and/or content management system 510 can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The experiment subsystem 520 and/or content management system 510 can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Some implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying a first text-based content item for display on a website;
determining, by one or more computers, a category of the first text-based content item;
evaluating text of the text-based content item;
determining, by one or more computers and based at least on the evaluation of the text-based content item, one or more textual characteristics of the first text-based content item, including determining at least one of formatting characteristics of the first text-based content item, punctuation characteristics of the first text-based content item, or displayed words of the first text-based content item that are displayed on a website during presentation of the first text-based content item;
identifying, based on real-time analysis of a plurality of content items, one or more other well-performing text-based content items in the plurality of content items and in the category;
evaluating the one or more other well-performing text-based content items;
determining, based at least on the evaluation of the one or more other well-performing text-based content items, one or more textual characteristics of the one or more other well-performing text-based content items, including determining at least one of formatting characteristics of the one or more other well-performing text-based content items, punctuation characteristics of the one or more other well-performing text-based content items, or displayed words of the one or more other well-performing text-based content items that are displayed on a website during presentation of the one or more other well-performing text-based content items;
contrasting, by one or more computers, the one or more textual characteristics of the first text-based content item with the one or more textual characteristics of the one or more other well-performing text-based content items;
based on the contrasting, determining a textual revision that comprises at least one of a suggested punctuation change, a suggested formatting change, or a suggested displayed word change to the first text-based content item including determining a suggestion that creates more similarity between the one or more textual characteristics of the first text-based content item and the one or more other well-performing text-based content items than originally existed; and
receiving, from a sponsor of the first text-based content item, at least one of (i) a command to submit the first text-based content item for serving, (ii) a replacement text-based content item, or (iii) an approval of the at least one of the suggested punctuation change, the suggested formatting change, or the suggested displayed word change.

2. The method of claim 1, wherein the one or more well-performing text-based content items are those with click through rates above a threshold.

3. The method of claim 1, wherein determining one or more textual characteristics of the one or more other well-performing text-based content items comprises using logistic regression on data obtained from using log analysis on click-through data or impression data of the one or more other well-performing text-based content items.

4. The method of claim 1, wherein the replacement text-based content item includes textual revisions to the first text-based content item that create more similarity between the one or more characteristics of the first text-based content item and the one or more characteristics of the one or more other well-performing text-based content items.

5. The method of claim 1, wherein the approval of the at least one of the suggested punctuation change, the suggested formatting change, or the suggested displayed word change comprises:
receiving, from the sponsor, a command to accept the at least one of the suggested punctuation change, the suggested formatting change, or the suggested displayed word change and to submit the first text-based content item for serving.

6. The method of claim 1, comprising:
receiving, from the sponsor, one or more commands to contrast one or more textual characteristics of a revised text-based content item with the one or more textual characteristics of the one or more other well-performing text-based content items; and
rejecting the revised text-based content item for additional contrasting after receiving a particular number of the one or more commands to contrast the one or more textual characteristics of the revised text-based content item with the one or more textual characteristics of the one or more other well-performing text-based content items.

7. The method of claim 1, wherein determining a category of the text-based content item comprises receiving, from the sponsor associated with the text-based content item, the category of the text-based content item.

8. A system comprising:
one or more computers and one or more storage devices storing instructions that are operable, when executed by the one or more computers, to cause the one or more computers to perform operations comprising:
identifying a first text-based content item for display on a website;
determining, by one or more computers, a category of the first text-based content item;
evaluating text of the text-based content item;
determining, by one or more computers and based at least on the evaluation of the text-based content item, one or more textual characteristics of the first text-based content item, including determining at least one of formatting characteristics of the first text-based content item, punctuation characteristics of the first text-based content item, or displayed words of the first text-based content item that are displayed on a website during presentation of the first text-based content item;
identifying, based on real-time analysis of a plurality of content items, one or more other well-performing text-based content items in the plurality of content items and in the category;
evaluating the one or more other well-performing text-based content items;
determining, based at least on the evaluation of the one or more other well-performing text-based content items, one or more textual characteristics of the one or more other well-performing text-based content items, including determining at least one of formatting characteristics of the one or more other well-performing text-based content items, punctuation characteristics of the one or more other well-performing text-based content items, or displayed words of the one or more other well-performing text-based content items that are displayed on a website during presentation of the one or more other well-performing text-based content items;
contrasting, by one or more computers, the one or more textual characteristics of the first text-based content item with the one or more textual characteristics of the one or more other well-performing text-based content items;
based on the contrasting, determining a textual revision that comprises at least one of a suggested punctuation change, a suggested formatting change, or a suggested displayed word change to the first text-based content item including determining a suggestion that creates more similarity between the one or more textual characteristics of the first text-based content item and the one or more other well-performing text-based content items than originally existed; and
receiving, from a sponsor of the first text-based content item, at least one of (i) a command to submit the first text-based content item for serving, (ii) a replacement text-based content item, or (iii) an approval of the at least one of the suggested punctuation change, the suggested formatting change, or the suggested displayed word change.

9. The system of claim 8, wherein the one or more well-performing text-based content items are those with click through rates above a threshold.

10. The system of claim 8, wherein determining one or more textual characteristics of the one or more other well-performing text-based content items comprises using logistic regression on data obtained from using log analysis on click-through data or impression data of the one or more other well-performing text-based content items.

11. The system of claim 8, wherein the replacement text-based content item includes textual revisions to the first text-based content item that create more similarity between the one or more characteristics of the first text-based content item and the one or more characteristics of the one or more other well-performing text-based content items.

12. The system of claim 8, wherein the approval of the at least one of the suggested punctuation change, the suggested formatting change, or the suggested displayed word change comprises:
receiving, from the sponsor, a command to accept the at least one of the suggested punctuation change, the suggested formatting change, or the suggested displayed word change and to submit the first text-based content item for serving.

13. The system of claim 8, the operations further comprising:
receiving, from the sponsor, one or more commands to contrast one or more textual characteristics of a revised text-based content item with the one or more textual characteristics of the one or more other well-performing text-based content items; and
rejecting the revised text-based content item for additional contrasting after receiving a particular number of the one or more commands to contrast the one or more textual characteristics of the revised text-based content item with the one or more textual characteristics of the one or more other well-performing text-based content items.

14. The system of claim 8, wherein determining a category of the text-based content item comprises receiving, from the sponsor associated with the text-based content item, the category of the text-based content item.

15. A non-transitory computer-readable medium storing software comprising instructions executable by one or more computers which, upon such execution, cause the one or more computers to perform operations comprising:
identifying a first text-based content item for display on a website;
determining, by one or more computers, a category of the first text-based content item;
evaluating text of the text-based content item;
determining, by one or more computers and based at least on the evaluation of the text-based content item, one or more textual characteristics of the first text-based content item, including determining at least one of formatting characteristics of the first text-based content item, punctuation characteristics of the first text-based content item, or displayed words of the first text-based content item that are displayed on a website during presentation of the first text-based content item;
identifying, based on real-time analysis of a plurality of content items, one or more other well-performing text-based content items in the plurality of content items and in the category;
evaluating the one or more other well-performing text-based content items;
determining, based at least on the evaluation of the one or more other well-performing text-based content items, one or more textual characteristics of the one or more other well-performing text-based content items, including determining at least one of formatting characteristics of the one or more other well-performing text-based content items, punctuation characteristics of the one or more other well-performing text-based content items, or displayed words of the one or more other well-performing text-based content items that are displayed on a website during presentation of the one or more other well-performing text-based content items;
contrasting, by one or more computers, the one or more textual characteristics of the first text-based content item with the one or more textual characteristics of the one or more other well-performing text-based content items;
based on the contrasting, determining a textual revision that comprises at least one of a suggested punctuation change, a suggested formatting change, or a suggested displayed word change to the first text-based content item including determining a suggestion that creates more similarity between the one or more textual characteristics of the first text-based content item and the one or more other well-performing text-based content items than originally existed; and
receiving, from a sponsor of the first text-based content item, at least one of (i) a command to submit the first text-based content item for serving, (ii) a replacement text-based content item, or (iii) an approval of the at least one of the suggested punctuation change, the suggested formatting change, or the suggested displayed word change.

16. The medium of claim 15, wherein the one or more well-performing text-based content items are those with click through rates above a threshold.

17. The medium of claim 15, wherein the replacement text-based content item includes textual revisions to the first text-based content item that create more similarity between the one or more characteristics of the first text-based content item and the one or more characteristics of the one or more other well-performing text-based content items.

18. The medium of claim 15, wherein the approval of the at least one of the suggested punctuation change, the suggested formatting change, or the suggested displayed word change comprises:
receiving, from the sponsor, a command to accept the at least one of the suggested punctuation change, the suggested formatting change, or the suggested displayed word change and to submit the first text-based content item for serving.

19. The medium of claim 15, the operations further comprising:
receiving, from the sponsor, one or more commands to contrast one or more textual characteristics of a revised text-based content item with the one or more textual characteristics of the one or more other well-performing text-based content items; and
rejecting the revised text-based content item for additional contrasting after receiving a particular number of the one or more commands to contrast the one or more textual characteristics of the revised text-based content item with the one or more textual characteristics of the one or more other well-performing text-based content items.

20. The medium of claim 15, wherein determining a category of the text-based content item comprises receiving, from the sponsor associated with the text-based content item, the category of the text-based content item.

21. The method of claim 1, wherein:
the one or more textual characteristics of the first content item includes the formatting characteristics of the first text-based content item, and
the one or more textual characteristics of the one or more other well-performing text-based content items includes the formatting characteristics of the one or more other well-performing text-based content items.

22. The method of claim 1, wherein:
the one or more textual characteristics of the first content item includes the punctuation characteristics of the first text-based content item, and
the one or more textual characteristics of the one or more other well-performing text-based content items includes the punctuation characteristics of the one or more other well-performing text-based content items.

23. The method of claim 1, wherein:
the one or more textual characteristics of the first content item includes the displayed words of the first text-based content item that are displayed on a website during presentation of the first text-based content item, and
the one or more textual characteristics of the one or more other well-performing text-based content items includes the displayed words of the one or more other well-performing text-based content items that are displayed on a website during presentation of the one or more other well-performing text-based content items.
